(19) United States
(12) Patent Application Publication
(10) Pub. No.: US 2026/0337523 A1
(43) Pub. Date: Oct. 29, 2026

(54) BIODEGRADABLE SOIL RELEASE POLYESTER POLYMER AND THE CLEANING COMPOSITION COMPRISING THE SAME

(71) Applicant: SPECIALTY OPERATIONS FRANCE, Lyon (FR)

(72) Inventors: Wojciech Bzducha, Courbevoie (FR); David James Wilson, LA POMAREDE (FR); Sujandi Zhou, Singapore (SG); Galder Cristobal, Bristol, PA (US); Wenting Shen, Shanghai (CN); Laurianne Timbart, Aubervilliers (FR)

(73) Assignee: SPECIALTY OPERATIONS FRANCE, Lyon (FR)

(21) Appl. No.: 19/100,447

(22) PCT Filed: Aug. 8, 2023
(86) PCT No.: PCT/CN2023/111609

§ 371 Date: Jan. 31, 2025

(30) Foreign Application Priority Data
Aug. 8, 2022 (WO) PCT/CN2022/110759

(51) Int. Cl. C11D 3/37; C08G 63/688; C11D 1/22; C11D 1/72; C11D 3/00; C11D 9/02; C11D 10/04

(52) U.S. Cl. CPC C11D 3/3715; C08G 63/6886; C11D 3/0036; C11D 10/045; C08G 2230/00; C11D 1/22; C11D 1/72; C11D 9/02

(57) ABSTRACT

Provided is a soil release polyester polymer which is biodegradable and has favorable soil releasing performance. In another aspect provided is a cleaning composition comprising the same.

This application claims priority(ies) filed on 8 Aug. 2022 in INTERNATIONAL PROCEDURE with Nr CN2022/110759, the whole content of this application being incorporated herein by reference for all purposes.

### FIELD OF THE INVENTION

The present invention provides a soil release polyester polymer which is biodegradable and has favorable soil releasing and anti-greying performance. In another aspect the invention also provides a cleaning composition comprising the same.

### BACKGROUND OF THE INVENTION

Soil release agents are key ingredients in cleaning compositions, i.e., textiles, laundry and hard surfaces such as carpet-cleaning and textile treating.

A variety of soil release compositions have been introduced and are known in the art. The soil release compositions often contain polymers such as amphiphilic compounds based on a polyester backbone. These backbones can be copolymers of ethylene glycol and terephthalic acids or polyethylene terephthalate and polyethylene glycol polyester polyether. These polymers consist of hydrophilic and hydrophobic units and are analogous to synthetic fibers such as those found in polyester fabrics which contain terephthalate, ethyleneoxy or propyleneoxy polymeric units. The similarity in chemical structure of soil release polymers and polyester synthetic fabrics allow for binding or deposition of soil release polymers onto fibers and modify surface energy by imparting hydrophilic characteristics to fiber. This results in better cleaning by either retarding the attachment of oily soil to fibers and thus minimizes subsequent soiling or improving the wetting of fibers and susceptibility of a fabric to detergent during washing and thus, to facilitate soil removal.

Soil release polymers (SRPs), especially when they are formulated in cleaning formulations such as a fabric care composition, a dish cleaning composition, a home care composition, a personal care composition or a health care composition, are considered as environmental chemicals, i.e. substances that enter the environment after their use. These chemicals go down to the drain and enter receiving waters directly or after sewage treatment increasing the chemical load of surface waters. Rapid ultimate biodegradation of a soil release polymer to mineralization products (carbon dioxide, water, inorganic salts) is most desirable mechanism for its ultimate removal from sewages, surface waters and soils.

U.S. Pat. No. 6,579,466B1 disclosed a sulphonated polyesters and a detergent composition comprising the same, wherein the sulphonated polyesters showed good antisoiling property, however it doesn't show good biodegradability.

Therefore it is still desirable to develop a soil release polymer which is biodegradable and possess favorable soil releasing performance.

### SUMMARY OF THE INVENTION

In one aspect of the present invention, it is provided a biodegradable soil release polyester polymer represented by the general formula (I)

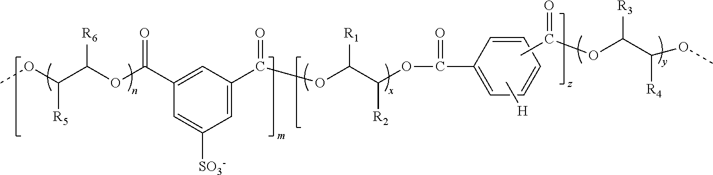

Wherein
R₁, R₂, R₃, R₄, R₅ and R₆ are independently selected from H or C₁-C₈ alkyl, preferably methyl or propyl;
x is a number ranging from 1 to 220;
y is a number ranging from 1 to 50;
z is a number ranging from 1 to 70;
m is a number ranging from 1 to 70; and
n is a number ranging from 1 to 220.

In one embodiment of the present invention, the biodegradable soil release polyester polymer is prepared from a monomer composition comprising:
(a) a sulphonated dicarboxylic acid or the C₂ to C₆ fatty dihydric alcohol ester thereof (SA), wherein the sulphonated dicarboxylic acid (SA) is selected from the group consisting of at least one sulphonated aromatic or sulphonated aliphatic dicarboxylic acid or the derivatives thereof;
(b) a polyhydric polyol (P) selected from the polyethylene glycol or polypropylene glycol or the copolymer thereof having an alkylene oxide number ranging from 1 to 200;
(c) a diacidic component which is at least one selected from
   c1) an unsulphonated dicarboxylic acid monomer (A) consisting of at least one dicarboxylic acid or derivatives thereof selected from the group consisting of terephthalic, isophthalic, 2,6-naphthalenedicarboxylic acids and furan dicarboxylic acid; and
   c2) a polyester prepolymer prepared from the unsulphonated dicarboxylic acid monomers (A) or derivatives thereof and an alcohol selected from at least one of ethylene glycol, propylene glycol, diethylene glycol, triethylene glycol, tetraethylene glycol or polyethylene glycol having an ethylene oxide number ranging from 1 to 200, dipropylene glycol, glycerol, 1,2,4-butanetriol and 1,2,3-butanetriol, and oligomers of thereof having from 1 to 100 monomer units.

The biodegradable soil release polyester polymer provided by the present invention has favorable biodegradability and also endows favorable soil releasing performance and soil anti-redeposition performance to the cleaning composition comprising the same.

In another aspect of the present invention, it is provided a cleaning composition, comprising:
(I) surface-active agent more selected from the group consisting of anionic surfactants, cationic surfactants, nonionic surfactants, amphoteric surfactants, and the combination thereof, which presents in an amount ranging from 3 to 60 wt. % based on 100 wt. % of the cleaning composition; and
(II) the biodegradable soil release polyester polymer as described above.

In one embodiment of the present invention, the cleaning composition is a fabric care composition, dish cleaning composition, home care composition, personal care composition or health care composition.

In another embodiment of the present invention, the cleaning composition is a product selected from the group consisting of liquid laundry detergents, solid laundry detergents, laundry soap products, laundry spray treatment products, laundry pre-treatment products, hand dish washing detergents, automatic dishwashing detergents, a beauty care detergent, hard surface cleaning detergents, carpet cleaning detergents, a shampoo, and a household cleaning detergent.

In still another embodiment of the present invention, the composition is a laundry detergent composition.

### DETAILED DESCRIPTION

Throughout the description, including the claims, the term “comprising one” or “comprising a” should be understood as being synonymous with the term “comprising at least one”, unless otherwise specified. The terms “between” and “from . . . to . . . ” should be understood as being inclusive of the limits.

The articles “a”, “an” and “the” are used to refer to one or to more than one (i.e., to at least one) of the grammatical object of the article.

It should be noted that in specifying any range of concentration, weight ratio or amount, any particular upper concentration, weight ratio or amount can be associated with any particular lower concentration, weight ratio or amount, respectively.

As used herein, the term “alkyl” means a saturated hydrocarbon radical, which may be straight, branched or cyclic, such as, methyl, ethyl, n-propyl, iso-propyl, n-butyl, sec-butyl, t-butyl, pentyl, n-hexyl, cyclohexyl.

As used herein, the terminology “(Cn-Cm)” in reference to an organic group, wherein n and m are each integers, indicates that the group may contain from n carbon atoms to m carbon atoms per group.

### Biodegradable Soil Release Polyester Polymer

In one aspect of the present invention, it is provided a biodegradable soil release polyester polymer which is biodegradable and has favorable soil releasing performance and anti-redeposition performance. The biodegradable soil release polyester polymer can be represented by the general formula (I)

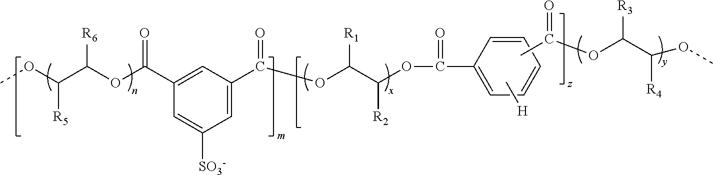

Wherein
x is a number ranging from 1 to 220;
y is a number ranging from 1 to 520;
z is a number ranging from 1 to 70;
m is a number ranging from 1 to 70; and
n is a number ranging from 1 to 220.

In one embodiment of the present invention, the biodegradable soil release polyester polymer can be prepared from a monomer composition comprising:
(a) a sulphonated dicarboxylic acid or the C₂ to C₆ fatty dihydric alcohol ester thereof (SA), wherein the sulphonated dicarboxylic acid (SA) is selected from the group consisting of at least one sulphonated aromatic or sulphonated aliphatic dicarboxylic acid or the derivatives thereof;
(b) a polyhydric polyol (P) selected from the polyethylene glycol or polypropylene glycol or the copolymer thereof having an alkylene oxide number ranging from 1 to 200;
(c) a diacidic component which is at least one selected from
c1) an unsulphonated dicarboxylic acid monomer (A) consisting of at least one dicarboxylic acid or derivatives thereof selected from the group consisting of terephthalic, isophthalic, 2,6-naphthalenedicarboxylic acids and furan dicarboxylic acid; and
c2) a polyester prepolymer prepared from the unsulphonated dicarboxylic acid monomers (A) or derivatives thereof and an alcohol selected from at least one of ethylene glycol, propylene glycol, diethylene glycol, triethylene glycol, tetraethylene glycol or polyethylene glycol having an ethylene oxide number ranging from 1 to 200, dipropylene glycol, glycerol, 1,2,4-butanetriol and 1,2,3-butanetriol, and oligomers of thereof having from 1 to 100 monomer units.

The sulphonated dicarboxylic acid monomer (SA) has at least one sulphonic acid group, preferably in the form of an alkali metal (preferably sodium) sulphonate, and two acidic functional groups or acidic functional group equivalents (that is to say an anhydride functional group or two ester functional groups) attached to one or a number of aromatic rings, when aromatic dicarboxylic acids or anhydrides or their diesters are involved, or to the aliphatic chain when aliphatic dicarboxylic acids or anhydrides or their alkyl diesters are involved.

Among the sulphonated dicarboxylic acid monomers (SA), there may be mentioned aromatic sulphonated dicarboxylic acids or anhydrides such as sulphoisophthalic, sulphoterephthalic, sulpho-ortho-phthalic acids or anhydrides, 4-sulpho-2,7-naphthalenedicarboxylic acids or anhydrides, sulpho-4,4′-bis(hydroxycarbonyl)diphenyl sulphones, sulphodiphenyldicarboxylic acids or anhydrides, sulpho-4,4′-bis(hydroxycarbonyl)diphenylmethanes, sulpho-5-phenoxyisophthalic acids or anhydrides or their lower (methyl, ethyl, propyl, isopropyl, butyl) diesters and sulphonated aliphatic sulphonated dicarboxylic acids or anhydrides such as sulphosuccinic acids or anhydrides or their lower (methyl, ethyl, propyl, isopropyl, butyl) diester. In one embodiment of the present invention, the sulphonated dicarboxylic acid monomers (SA) are selected from aromatic sulphonated dicarboxylic acids, preferably sulphoisophthalic, sulphoterephthalic, sulpho-ortho-phthalic acids or anhydrides lower diesters thereof.

In the present invention, the biodegradable soil release polyester polymers are anionic polyester because of the incorporation of the sulphonated dicarboxylic acid monomers.

The polyhydric polyol (P) used in the present invention is selected from the polyethylene glycol or polypropylene glycol or the copolymer thereof having an alkylene oxide number ranging from 1 to 200, preferably 8 to 200, more preferably 18 to 200, corresponding to a molecular weight of 44 to 8800, preferably 350 to 8800, more preferably 792 to 8800.

In one embodiment of the present invention, the unsulphonated dicarboxylic acid monomers (A) are consisted of isophthalic and/or furan dicarboxylic acids.

In the unsulphonated dicarboxylic acid monomer (A) there may additionally be present minor quantities of aromatic diacids other than those mentioned above, such as isophthalic acid, orthophthalic acid, anthracene, 1,8-naphthalene, 1,4-naphthalene and biphenyl dicarboxylic acids or aliphatic diacids such as adipic, glutaric, succinic, trimethyladipic, pimelic, azelaic, sebacic, suberic, itaconic and maleic acids, etc. in the form of acid, anhydride or lower (methyl, ethyl, propyl, isopropyl, butyl) diesters.

The prepolymer c2) used in the present invention is prepared from the unsulphonated dicarboxylic acid monomers (A) or the derivatives thereof and the polyhydric polyol (P). In one embodiment of the present invention, the prepolymer c2) is polyethylene terephthalate which can be prepared from terephthalic acid, isophthalic acid, ethylene glycol and/or diethylene glycol. Preferably the prepolymer c2) has an intrinsic viscosity range between 0.1 to 0.9 dL/g determined according to ASTM method D-4603 and has a maximum melting point of 250° C.

The biodegradable soil release polyester polymer of the present invention can be prepared by the process of esterification or transesterification and polycondensation according to the common knowledge in the art. U.S. Ser. No. 09/887,664 discloses such a process of preparing the water-dispersible polyester polymer, which are hereby incorporated herein by reference in their entirety.

In one embodiment of the present invention, the biodegradable soil release polyester polymer is prepared by transesterification reaction among the sulphonated dicarboxylic acid of C2 to C6 fatty dihydric alcohol ester (SA), polyhydric polyol (P) and the diacid component.

### The Cleaning Composition

In the present invention, it is further provided a cleaning composition, comprising:
(I) 3 to 60% by weight of surface-active agent which is one or more selected from the group consisting of anionic surfactants, cationic surfactants, nonionic surfactants, and amphoteric surfactants; and
(II) the biodegradable soil release polyester polymer as elaborated above.

In the present invention, the composition is a fabric care composition, dish cleaning composition, home care composition, personal care composition or health care composition.

As used herein, the term “cleaning composition” includes, but is not limited to, laundry cleaning compositions, laundry soap products, fabric care compositions, hard surface cleaning compositions, dish cleaning compositions, home care cleaning compositions, and personal care cleaning compositions, for example, for use in the health and beauty area. Cleaning compositions include granular, powder, liquid (including heavy duty liquid (“HDL”) detergents), gel, paste, bar form and/or flake type cleaning agents, laundry detergent cleaning agents, laundry soak or spray treatments and pre-treatments, fabric treatment compositions, dish washing detergents and soaps, shampoos, hand washing compositions, body washes and soaps, and other similar cleaning compositions.

As used herein, the term “fabric treatment composition” includes, unless otherwise indicated, fabric softening compositions, fabric enhancing compositions, fabric freshening compositions and combinations thereof. Such compositions may be, but need not be wash or rinse added compositions.

As used herein, the term “personal care cleaning composition” includes shampoos, hand washing compositions, body washing compositions, hair removal compositions, bath soaps, bar soaps, bath beads, cosmetics, beauty bars, and lotions.

Examples of cleaning compositions include, but are not limited to, liquid laundry detergents, solid laundry detergents, laundry soap products, laundry spray treatment products, laundry pre-treatment products, hand dish washing detergents, automatic dishwashing detergents, a beauty care detergent, hard surface cleaning detergents, carpet cleaning detergents, a shampoo, and a household cleaning detergent.

Examples of fabric care compositions suitable for the present disclosure include, but are not limited to, liquid laundry detergents, heavy duty liquid laundry detergents, solid laundry detergents, laundry soap products, laundry spray treatment products, laundry pre-treatment products, laundry soak products, heavy duty liquid detergents, and rinse additives.

Examples of suitable dish cleaning compositions include, but are not limited to, automatic dishwasher detergents, detergents for hand washing of dishes, liquid dish soap, and solid granular dish soap.

Examples of suitable home care compositions include, but are not limited to, rug or carpet cleaning compositions, hard surface cleaning detergents, floor cleaning compositions, window cleaning compositions, toilet and bathroom cleaning compositions, household cleaning detergents, and car washing detergents.

Examples of suitable personal care compositions include, but are not limited to, beauty care detergents, beauty bars, bar soap, bath beads, bath soaps, hand washing compositions, body washes and soaps, shampoo, conditioners, cosmetics, and hair removal compositions.

Examples of suitable health care compositions include, but are not limited to, oral and dental care compositions.

In one embodiment of the present invention, the cleaning composition is a laundry detergent composition.

In another embodiment of the present invention, the cleaning composition is a solid laundry detergent or laundry soap product.

The anionic surfactants contemplated in the present invention as surface-active agent comprise the major active components in conventional detergent systems, including any of the known hydrophobes attached to a carboxylate, sulphonate, sulfate or phosphate polar, solubilizing group including salts. Salts may be the sodium, potassium, ammonium and amine salts of such surfactants. Useful anionic surface-active agents can be organic sulfuric reaction products having in their molecular structure an alkyl group containing from about 8 to about 22 carbon atoms and a sulfonic acid or sulfuric acid ester group, or mixtures thereof. (Included in the term “alkyl” is the alkyl portion of acyl groups.) Examples of this group of synthetic detersive surfactants which can be used in the present invention are the alkyl sulfates, especially those obtained by sulfating the higher alcohols (C8-C18 carbon atoms) produced from the glycerides of tallow or coconut oil; and alkyl benzene sulphonates.

Other useful anionic surface-active agents herein include the esters of alpha-sulphonated fatty acids preferably containing from about 6 to 20 carbon atoms in the ester group; 2-acyloxyalkane-1-sulfonic acids preferably containing from about 2 to 9 carbon atoms in the acyl group and from about 9 to about 23 carbon atoms in the alkane moiety; alkyl ether sulfates preferably containing from about 10 to 20 carbon atoms in the alkyl group and from about 1 to 30 moles of ethylene oxide; olefin sulphonates preferably containing from about 12 to 24 carbon atoms; and beta-alkyloxy alkane sulphonates preferably containing from about 1 to 3 carbon atoms in the alkyl group and from about 8 to 20 carbon atoms in the alkane moiety.

Anionic surface-active agents based on the higher fatty acids, i.e., “soaps” are useful anionic surfactants herein. Higher fatty acids containing from about 8 to about 24 carbon atoms and preferably from about 10 to about 20 carbon atoms and the coconut and tallow soaps can also be used herein as corrosion inhibitors.

Preferred water-soluble anionic organic surfactants herein include linear alkyl benzene sulphonates containing from about 10 to about 18 carbon atoms in the alkyl group; branched alkyl benzene sulphonates containing from about 10 to about 18 carbon atoms in the alkyl group; the tallow range alkyl sulfates; the coconut range alkyl glyceryl sulphonates; alkyl ether (ethoxylated) sulfates wherein the alkyl moiety contains from about 12 to 18 carbon atoms and wherein the average degree of ethoxylation varies between 1 and 12, especially 3 to 9; the sulfated condensation products of tallow alcohol with from about 3 to 12, especially 6 to 9, moles of ethylene oxide; and olefin sulphonates containing from about 14 to 16 carbon atoms.

Specific preferred anionics for use herein include: the linear C₁₀-C₁₄ alkyl benzene sulphonates (LAS); the branched C₁₀-C₁₄ alkyl benzene sulphonates (ABS); the tallow alkyl sulfates, the coconut alkyl glyceryl ether sulphonates; the sulfated condensation products of mixed C₁₀-C₁₈ tallow alcohols with from about 1 to about 14 moles of ethylene oxide; and the mixtures of higher fatty acids containing from 10 to 18 carbon atoms.

It is to be recognized that any of the foregoing anionic surfactants can be used separately herein or as mixtures. Moreover, commercial grades of the surfactants can contain non-interfering components which are processing by-products. For example, commercial alkaryl sulphonates, preferably C₁₀-C₁₄, can comprise alkyl benzene sulphonates, alkyl toluene sulphonates, alkyl naphthalene sulphonates and alkyl poly-benzenoid sulphonates. Such materials and mixtures thereof are fully contemplated for use herein.

Other examples of the anionic surfactants used herein include fatty acid soaps, ether carboxylic acids and salts thereof, alkane sulphonate salts, α-olefin sulphonate salts, sulphonate salts of higher fatty acid esters, higher alcohol sulfate ester or ether ester salts, alkyl, preferably higher alcohol phosphate ester and ether ester salts, and condensates of higher fatty acids and amino acids.

Fatty acid soaps include those having the formula: R—C(O)OM, wherein R is C₆ to C₂₂ alkyl and M is preferably sodium.

Salts of ether carboxylic acids and salts thereof include those having the formula: R—(OR¹)ₙ—OCH₂C(O)OM, wherein R is C₆ to C₂₂ alkyl, R¹ is C₂ to C₁₀, preferably C₂ alkyl, and M is preferably sodium.

Alkane sulphonate salts and α-olefin sulphonate salts have the formula: R—SO₃M, wherein R is C₆ to C₂₂ alkyl or α-olefin, respectively, and M is preferably sodium.

Sulphonate salts of higher fatty acid esters include those having the formula:

RC(O)O—R¹—SO₃M,
wherein R is C₁₂ to C₂₂ alkyl, R¹ is C₁ to C₁₈ alkyl and M is preferably sodium.

Higher alcohol sulfate ester salts include those having the formula:

RC(O)O—R¹—OSO₃M,
wherein R is C₁₂-C₂₂ alkyl, R¹ is C₁-C₁₈ hydroxyalkyl, M is preferably sodium.

Higher alcohol sulfate ether ester salts include those having the formula:

RC(O)(OCH₂CH₂)ₓ—R¹—OSO₃M,
wherein R is C₁₂-C₂₂ alkyl, R¹ is C₁-C₁₈ hydroxyalkyl, M is preferably sodium and x is an integer from 5 to 25.

Higher alcohol phosphate ester and ether ester salts include compounds of the formulas:

R—(OR¹)n-OPO(OH)(OM);

(R—(OR¹)n-O)₂PO(OM); and

(R—(OR¹)ₙ—O)₃—PO,
wherein R is alkyl or hydroxyalkyl of 12 to 22 carbon atoms, R¹ is C₂H₄, n is an integer from 5 to 25, and M is preferably sodium.

Other anionic surface-active agents herein are sodium coconut oil fatty acid monoglyceride sulphonates and sulfates; sodium or potassium salts of alkyl phenol ethylene oxide ether sulfates containing from about 1 to about 10 units of ethylene oxide per molecule and wherein the alkyl groups contain from about 8 to about 12 carbon atoms; and sodium or potassium salts of alkyl ethylene oxide ether sulfates containing about 1 to about 10 units of ethylene oxide per molecule and wherein the alkyl group contains from about 10 to about 20 carbon atoms.

The nonionic surfactants which can be contemplated in the present invention as surface-active agent can be one or more selected from the group consisting of:
polyoxyalkylenated (polyethoxyethylenated, polyoxypropylenated, polyoxybutylenated) alkylphenols in which the alkyl substituent is C₆-C₁₂ and containing from 5 to 25 oxyalkylene units; the examples which may be mentioned are Tritons X-45, X-114, X-100 or X-102, marketed by Rohm & Haas Co.;
glucosamide, glucamide, glycerolamide;
polyoxyalkylenated C9-C22 aliphatic alcohols containing from 1 to 25 oxyalkylene (oxyethylene, oxypropylene) units; examples which may be mentioned are Tergitol 15-S-9, Tergitol 24-L-6 NMW marketed by Union Carbide Corp., Neodol 45-9, Neodol 23-65, Neodol 45-7, Neodol 45-4 marketed by Shell Chemical Co. and Kyro EOB marketed by the Procter & Gamble Co.;
the products resulting from the condensation of ethylene oxide, the compound resulting from the condensation of propylene oxide with propylene glycol, such as the Pluronics marketed by BASF;
the products resulting from the condensation of ethylene oxide, the compound resulting from the condensation of propylene oxide with ethylenediamine, such as the Tetronics marketed by BASF;
amine oxides such an (C₁₀-C₁₃ alkyl)dimethylamine oxides and (C₅-C₂₂ alkoxy)ethyldihydroxyethylamine oxides;
the alkylpolyglycosides described in U.S. Pat. No. 4,565,647;
C₈-C₂₀ fatty acid aides
ethoxylated fatty acids
ethoxylated fatty amides
ethoxylated amines.

The catonic surfactants which can be contemplated in the present invention as surface-active agent can be one or more selected from the group consisting of: alkyldimethylammonium halides.

The amphoteric surfactants which can be contemplated in the present invention as surface-active agent can be one or more selected from the group consisting of:
alkyldimetlylbetaines, alkylamidopropyldimethylbetaines, alkyltrimethylsulphobetaines, the products of condensation of fatty acids and of protein hydrolysates;
alkylamphoacetates or alkylamphodiacetates in which the alkyl group contains from 6 to 20 carbon atoms.

The cleaning compositions of the present invention may further include detergency builders selected from any of the conventional inorganic and organic water-soluble builder salts, including neutral or alkaline salts, as well as various water-insoluble and so-called “seeded” builders.

Builders are preferably selected from the various water-soluble, alkali metal, ammonium or substituted ammonium phosphates, polyphosphates, phosphonates, polyphosphonates, carbonates, silicates, borates, polyhydroxysulphonates, polyacetates, carboxylates, and polycarboxylates. Most preferred are the alkali metal, especially sodium, salts of the above.

Specific examples of inorganic phosphate builders are sodium and potassium tripolyphosphate, pyrophosphate, polymeric metaphosphate having a degree of polymerization of from about 6 to 21, and orthophosphate. Examples of polyphosphonate builders are the sodium and potassium salts of ethylene-1, 1-diphosphonic acid, the sodium and potassium salts of ethane 1-hydroxy-1, 1-diphosphonic acid and the sodium and potassium salts of ethane, 1,1,2-triphosphonic acid.

Examples of non-phosphorus, inorganic builders are sodium and potassium carbonate, bicarbonate, sesquicarbonate, tetraborate decahydrate, and silicate having a molar ratio of SiO₂ to alkali metal oxide of from about 0.5 to about 4.0, preferably from about 1.0 to about 2.4.

Water-soluble, non-phosphorus organic builders useful herein include the various alkali metal, ammonium and substituted ammonium polyacetates, carboxylates, polycarboxylates and polyhydroxysulphonates. Examples of polyacetate and polycarboxylate builders are the sodium, potassium, lithium, ammonium and substituted ammonium salts of ethylenediamine tetracetic acid, nitrilotriacetic acid, oxydisuccinic acid, mellitic acid, benzene polycarboxylic acids, and citric acid.

Highly preferred polycarboxylate builders herein are set forth in U.S. Pat. No. 3,308,067 to Diehl, which is again incorporated herein by reference. Such materials include the water-soluble salts of homo- and copolymers of aliphatic carboxylic acids such as maleic acid, itaconic acid, mesaconic acid, fumaric acid, aconitic acid, citraconic acid and methylenemalonic acid.

Other builders include the carboxylated carbohydrates of U.S. Pat. No. 3,723,322 to Diehl which is incorporated herein by reference.

Other useful builders herein are sodium and potassium carboxymethyloxymalonate, carboxymethyloxysuccinate, ciscyclohexanehexacarboxylate, cis-cyclopentanetetracarboxylate phloroglucinol trisulphonate, water-soluble polyacrylates (having molecular weights of from about 2,000 to about 200,000 for example), and the copolymers of maleic anhydride with vinyl methyl ether or ethylene.

Other suitable polycarboxylates for use herein are the polyacetal carboxylates described in U.S. Pat. Nos. 4,144,226, and 4,246,495, both to Crutchfield et al.; both of which are incorporated herein by reference.

“Insoluble” builders include both seeded builders such as 3:1 weight mixtures of sodium carbonate and calcium carbonate; and 2.7:1 weight mixtures of sodium sesquicarbonate and calcium carbonate. Amorphous and crystalline alumino silicates such as hydrated sodium Zeolite A are commonly used in laundry detergent applications. They have a particle size diameter of 0.1 micron to about 10 microns depending on water content of these molecules. These are referred to as ion exchange materials. Crystalline alumino silicates are characterized by their calcium ion exchange capacity. Amorphous alumino silicates are usually characterized by their magnesium exchange capacity. They can be naturally occurring or synthetically derived.

A detailed listing of suitable detergency builders can be found in U.S. Pat. No. 3,936,537 to Baskerville, et al. which is also incorporated herein by reference.

Cleaning composition components may also include any one or more of a number of miscellaneous ingredients including hydrotropes, enzymes (e.g., proteases, amylases and cellulases), enzyme stabilizing agents, pH adjusting agents (monoethanolamine, sodium carbonate, etc.) halogen bleaches (e.g., sodium and potassium dichloroisocyanurates), peroxyacid bleaches (e.g., diperoxydodecane-1,1 2-dioic acid), inorganic per compound bleaches (e.g., sodium perborate), antioxidants as optional stabilizers, reductive agents, activators for per compound bleaches (e.g., tetra-acetylethylenediamine and sodium nonanoyloxybenzene sulphonate), soil suspending agents (e.g., sodium carboxymethyl cellulose), soil anti-redisposition agents, corrosion inhibitors, perfumes and dyes, buffers, whitening agents, solvents (e.g., glycols and aliphatic alcohols) and optical brighteners. Any of other commonly used auxiliary additives such as inorganic salts and common salt, humectants, solubilizing agents, UV absorbers, softeners, chelating agents, static control agents and viscosity modifiers may be added to the cleaning compositions of the invention.

For bar compositions, processing aids are optionally used such as salts and/or low molecular weight alcohols such as monodihydric, dihydric (glycol, etc.), trihydric (glycerol, etc.), and polyhydric (polyols) alcohols. Bar compositions may also include insoluble particulate material components, referred to as “fillers” such as calcium carbonate, silica and the like.

The total weight percentages of the conventional surfactants of the present invention, all weight percentages being based on the total active weight of the compositions of this invention consisting of the nonionic ethoxylate and amphoteric surfactant(s), soil release agent(s), and (optionally) one or more other surfactants, detergency builder(s), additives and the like are about 10 to about 99.9 weight percent, preferably about 15-75 weight percent.

The long chain linear alkyl nonionic alcohol alkoxylates or amphoteric enhancers are combined with said biodegradable soil release polyester polymer in a weight ratio of from about 1:10 to about 10:1 respectively and preferably in a weight ratio of about 1:2 to about 2:1. The nonionic alcohol alkoxylates and amphoteric enhancers are incorporated in the total cleaning composition in an amount of from about 0.1 wt. % to 12 wt. % and preferably in an amount of from about 0.5 to 2.0 wt. %.

The biodegradable soil release polyester polymers are suitably employed at a level of from about 0.05 to about 40 wt. % active weight percent, preferably from about 0.2-15 wt. %, based on the total weight of the detergent formulation. The cmc lowering surfactants are incorporated into said soil release compositions with the soil release agent in a weight ratio of from about 1:10 to 10:1, respectively, and preferably in a weight ratio of about 1:2 to about 1:1. The soil release composition consisting of the soil release polymer and enhancer is incorporated in the total detergent formulation in an amount of from about 0.5 wt. % to about 15.0 wt. %.

The optional detergency builders are suitably present at a level of from about 0 to about 70 weight percent, preferably from about 5 to about 50 weight percent.

In the preparation of detergent and/or fabric softening compositions, other optional ingredients such as bleaches, enzymes, antioxidants, reductive agents, perfumes, fabric brighteners and the like may be included in amounts each of from about 0 to about 5 weight percent based on the active weight of the composition.

When the soil release compositions of the present invention are used in fabric softener compositions, they generally comprise from about 1 to 80 wt. % of a cationic conventional surfactant; and from about 0.005 to about 20, preferably 0.02-10 wt. % of the C12 to C22 amphoteric or long chain nonionic alkoxylate surfactant. They also contain about 0.1 to about 5, preferably about 0.2-3.0, most preferably about 0.2 to about 1.5 wt. % of polymeric soil release agent. Enhancer/polymer synergy enhances soil release and general detergency boosting benefits, and improves suspending/stabilizing properties of the polymeric suspending agents.

Other optional ingredients for liquid detergents include liquid carriers and adjuvants as disclosed by U.S. Pat. No. 5,402,542 to Trinh et al., which is incorporated herein by reference in its entirety.

The cleaning composition of the present invention could be in the form such as granular, powder, liquid, gel, paste, bar or the like. A person skilled in the art can decide suitable carries used in the composition. In case the cleaning composition is a liquid, the liquid carrier is preferably selected from the group consisting of water and mixtures of water and short chain C1-C6 monohydric or polyhydric alcohols. The water used can be distilled, deionized, or tap water. Mixtures of water and up to about 90% of a short chain alcohol such as ethanol, propanol, isopropanol or butanol, ethylene glycol, diethylene glycol, propylene glycol, dipropylene glycol, glycerol and mixtures thereof, are useful as the carrier liquid.

Adjuvants can be added to the softener compositions for their known purposes. Such adjuvants include, but are not limited to, clays, viscosity control agents, perfumes, emulsifiers, preservatives, anti-foaming agents, antioxidants, bactericides, fungicides, brighteners, opacifiers, freeze-thaw control agents, shrinkage control agents, and agents to provide ease of ironing. These adjuvants, if used, are added at their usual levels, generally each of up to about 5% by active weight of the composition.

### Example

### 1. The Preparation of the Biodegradable Soil Release Polymer (SRP)

The biodegradable soil release polymer S1 were prepared as follows:

### First Step: Esterification of Sodiosulfoisophthalic Acid Monomer:

Into a 500 mL glass reactor equipped with an anchor impeller, an electric jacket and a distillation column, were introduced 150 g of sulphoisophthalic acid (SSIA) (0.56 mol) and 350 g of ethylene glycol (5.64 mol). SSIA and the ethylene glycol were mixed together at 500 rpm and heated to 150° C. under nitrogen purge; The system was left under stirring at 150° C. till the solubilization of SSIA was complete. The system is then heated to 184° C. under nitrogen purge. Once at temperature, the solution was cooked at 182-185° C. for 2 h without purging with nitrogen. The obtained product was a clear viscous liquid. About 33.4 g of condensate was recovered.

### 2nd Step: Transesterification/Polycondensation

Into a 500 mL glass reactor equipped with an anchor impeller, an electric jacket and a distillation column, were introduced after inertion of the set up under nitrogen, are added 121.6 g of SSIA ester 50 wt % in ethylene glycol (0.34 mol), 198.4 g of Rhodasurf PEG 3,350 (0.059 mol) preheated at 70° C., 80 g of polyethylene terephthalate (PET) and 0.04 g of Tyzor TE (catalyst). The system was then heated slowly to 213° C. and held at temperature for 3 h under atmospheric pressure without nitrogen purge. Then; the solution was cooled down to 165° C. and vacuum was applied to remove the excess ethylene glycol. The reactor was then discharged. The obtained polyester S1 was a white solid with a Mn of 3,700 g/mol measured by GPC.

The biodegradable soil release polymer S2 was prepared according to the similar process as above except propylene glycol was used instead of ethylene glycol to prepare SSIA ester. S3 was prepared according to the similar process as above except a polyethylene glycol of 8000 molecular weight was used, S4 was prepared from a polyethylene glycol of 400 molecular weight, S5 was prepared from a polyethylene glycol of 6000 molecular weight.

The comparative soil release polymer CS1 and CS2 were prepared according to the similar process as above, except CS1 was prepared without polyethylene glycol, and CS2 was prepared with a polyethylene glycol of 3350 molecular weight and without SSIA, therefore CS2 was a nonionic polyester.

### 2. The Biodegradability Test

The biodegradability test is done according OECD (1992), Test No. 301F: Readily Biodegradable: Manometric Respirometry OECD Guidelines for the Testing of Chemicals, Section 6, OECD Publishing, Paris.

If the biodegradability test result is over 60% calculated based on the theoretical oxygen demand or ThOD and fulfilled the validity criteria of the test, it will be deemed as passing the readily biodegradability test.

As shown in the table 1, the biodegradable SRP polymers of the present invention has better biodegradability than those which don't comprise dihydroxyl compound (DH).

TABLE 1
the prepared biodegradable SRP polymers

| | S1 | S2 | S3 | S4 | S5 | CS1 | CS2 |
|---|---|---|---|---|---|---|---|
| Biodegradability | >60% | >60% | >60% | >60% | >60% | <60% | >60% |
| test (OECD301F, | | | | | | | |
| 28 days) | | | | | | | |

### 3. The Soil Release Performance Test

The soil release performance test was performed using a ECE-2-Color Fastness Test Detergent, (no phosphate), ISO 105 C 08 (1998) from WFK (code 88031). The composition of the detergent is listed in Table 2-1. The proportion of the soil release polymer with regard to the washing detergent according to Table 2-2 is 1.0% by weight of polymer active substance.

TABLE 2-1
ECE-2 compositions

| composition | Part by weight |
|---|---|
| Linear alkyl benzene sulphonate, sodium salt | 9.7 |
| Ethoxylated fatty alcohol C12-18 (7 EO units) | 5.2 |
| Sodium fatty acid soap (C12-20) | 3.6 |
| Foam inhibitor | 4.5 |
| Sodium aluminium silicate | 32.5 |
| Sodium carbonate | 11.8 |
| Sodium salt of copolymer from acrylic and | 5.2 |
| maleic acid | |
| Sodium Silicate | 3.4 |
| Carboxy methyl cellulose (CMC) | 1.3 |
| Diethylene triamine penta(methylene | 0.8 |
| phosphonic acid) | |
| Sodium Sulphate | 9.8 |
| Water | To 100 |

TABLE 2-2
ECE-2 compositions comprising Soil releasing polymer

| composition | Soil release polymer |
|---|---|
| Control | — |
| Comparative composition 1 | 1% CS1 |
| Comparative composition 2 | 1% CS2 |
| Composition 1 | 1% S1 |
| Composition 2 | 1% S2 |
| Composition 3 | 1% S3 |
| Composition 4 | 1% S4 |
| Composition 5 | 1% S5 |

The soil release performance is carried out on the following test fabrics:
Test fabric 1: 100% polyester, Style #777 from Testfabrics
Test fabric 2: 50%/50% polyester-cotton blend, Style #7422 from Testfabrics
Test fabric 3: 100% polyester, W-30A from CFT
Test fabric 4: 65%/35% polyester-cotton blend, W-20A from CFT

### Prewashing:

The test fabrics were cut into squares 7 cm×7 cm in size in three replicates and were prewashed in a Tergotometer for 20 minutes at 40° C. with the ECE-2 detergent. The water employed had a hardness of 25oFH with Ca:Mg molar ratio equal to 4:1 and the quantity of the washing detergent used was 5 grams per liter of water. The Tergotometer speed was set at 120 oscillations per minute.

The test fabric squares were then rinsed 3 times for 5 minutes with cold water (20° C.) and then dried.

### Staining:

After the test fabric squares were completely dried, they were stained using two drops of dirty motor oil (DMO) added from a 3 ml disposable pipette. The stained test fabric squares were left overnight before washing. To allow good reproducibility of the results the stained test fabrics squares were washed within 24 hours.

### Washing:

The washing was performed in the same conditions as the prewashing in a Tergotometer for 20 minutes at 40° C. with the laundry detergent compositions shown in Table 2. The water employed had a hardness of 25oFH with Ca:Mg molar ratio equal to 4:1 and the quantity of the washing liquid used was 5 grams per liter of water. The Tergotometer speed was set at 120 oscillations per minute.

The test fabric squares were then rinsed 3 times for 5 minutes with cold water (20° C.) and then dried.

### Evaluation:

The test fabric squares before staining (referred to as white), after staining (referred to as stain) and after washing (referred to as wash) were analyzed with the ColorQuest XE reflectance colorimeter from HunterLab to measure its initial CIEALAB color space (L*, a*, b*).

The effectiveness of the soil release polymers according to the present invention is assessed as the % of removal of the stain, calculated by the formula:

$$Stain Removal in \% = \frac{\sqrt{Δ {L}^{2} + Δ {a}^{2} + Δ {b}^{2}}}{\sqrt{Δ {L}^{′2} + Δ {a}^{′2} + Δ {b}^{′2}}}$$

Where:

ΔL=L*(wash)−L*(stain)

Δa=a*(wash)−a*(stain)

Δb=b*(wash)|b*(stain)

ΔL′=L*(white)−L*(stain)

Δa′=a*(white)−a*(stain)

Δb′=b*(white)−b*(stain)

The average of the % of stain removal is calculated for each test fabric. The results obtained are given in Table 3 which follows:

### Table 3: The Effectiveness of the Soil Release Polymer as the % of Stain Removal

TABLE 3-1

| | | Com- | Com- | | |
|---|---|---|---|---|---|
| | | parative | parative | Com- | Com- |
| Test | | com- | com- | position | position |
| fabrics | Control | position 1 | position 2 | 1 | 2 |
| Test | 22.83 | 65.29 | 59.97 | 42.75 | 54.64 |
| fabric 1 | | | | | |
| Test | 20.92 | 59.02 | 57.48 | 38.82 | 55.64 |
| fabric 2 | | | | | |
| Test | 31.58 | 45.14 | 47.88 | 42.00 | 45.27 |
| fabric 3 | | | | | |
| Test | 43.43 | 48.62 | 49.24 | 48.1 | 49.14 |
| fabric 4 | | | | | |
| Total | 118.76 | 218.06 | 214.6 | 171.67 | 204.69 |

TABLE 3-2

| Test | | Comparative | Comparative | Composi- | Composi- | Composi- |
|---|---|---|---|---|---|---|
| fabrics | Control | composition 1 | composition 2 | tion 3 | tion 4 | tion 5 |
| Test | 21.7 | 65.1 | 53.4 | 54 | 22.7 | 30.2 |
| fabric 1 | | | | | | |
| Test | 16.6 | 54.9 | 51.1 | 51.9 | 19.3 | 29.8 |
| fabric 2 | | | | | | |
| Test | 19.2 | 29 | 31.3 | 28.9 | 19.2 | 24.1 |
| fabric 3 | | | | | | |
| Test | 17.7 | 38.8 | 41.3 | 39.6 | 18 | 26.5 |
| fabric 4 | | | | | | |
| Total | 75.2 | 187.8 | 177.1 | 174.4 | 79.2 | 110.6 |

The test results in table 3-1 and table 3-2 were run at different batch, thus shown separately. As shown in table 3, compared to the washing detergent without polymer (i.e. Control), SRP polymers, including the comparative example 1 and 2, can improve the soil releasing performance of the washing detergent composition comprising the same. Compared to the comparative composition 1 & 2, which CS1 and CS2 are comprised, the compositions 1 to 5 which S1 to S5 are comprised have favorable soil releasing performance.

In general, the soil release polyester polymer of the present application not only readily biodegradable but also has favorable soil releasing performance.

### Soil Anti-Redeposition Performance.

The soil anti-redeposition performance was evaluated using a carbon black-sebum Bey soil composition according to Table xx. The soil was prepared by mixing 32.8 wt. % of Sebum Bey from WFK (Testgewebe GmbH) with 32.8 wt. % vegetable cooking oil from supermarket e.g. cooking oil derived from sun flower, 16.4 wt. % mineral oil from Aldrich and 16.4 wt. % propylene glycol at 60° C. The mixture was blended well with an overhead stirrer for 30 minutes to obtain homogenous mixture. To the mixture, 1.6 wt % carbon black from Aldrich was slowly added and stirred until homogeneous. The obtained carbon black-sebum Bey soil was used in the experiment while hot.

TABLE 4
Composition of the carbon black-sebum Bey soil

| Composition | Part by weight |
|---|---|
| Sebum Bey | 32.8 |
| Vegetable cooking oil | 32.8 |
| Mineral oil | 16.4 |
| Propylene glycol | 16.4 |
| Carbon black | 1.6 |

The soil anti-redepostion performance test was also performed using a ECE-2-Color Fastness Test Detergent, (no phosphate), ISO 105 C 08 (1998) from WFK (code 88031). The composition of the detergent is listed in Table 2-1. The proportion of the soil release polymer with regard to the laundry detergent according to Table 2-1 is 1.0% by weight of polymer active substance as table 2-2.

The soil anti-redeposition test performance is carried out on the following test fabrics:
Test fabric 1: 100% polyester, Style #777 from Testfabrics
Test fabric 2: 50%/50% polyester-cotton blend, Style #7422 from Testfabrics
Test fabric 3: 100% polyester, W-30A from CFT
Test fabric 4: 65%/35% polyester-cotton blend, W-20A from CFT
Test fabric 5: 100% Cotton from, W-10A from CFT
Test fabric 6: 100% Bleached Cotton, Interlock Knit, T-460 from Testfabrics

### Washing:

The test fabrics were cut into squares 7 cm×7 cm in size in three replicates and were washed in a Tergotometer with following conditions:
Washing temperature: 40° C.
Washing time: 20 minutes
Water volume: 1000 ml
Water hardness: 25ofH with Ca:Mg:HCO₃ molar ratio=4:1:8
Detergent dosage: 5.0 grams per liter of the washing liquor
Carbon black-sebum Bey soil dosage: 0.5 gram per liter of the washing liquor
Tergotometer rotation: 200 RPM.

After the wash, the fabrics were rinse twice with municipal tab water for 1 minute each. Finally, the fabrics were line-dried at temperature 22 degree centigrade with humidity of 60%. The washing was repeated 5 times.

### Evaluation:

The test fabric squares before washing experiment (referred to as white) and after 5 cumulative washes (referred to as wash) were analyzed with the ColorQuest XE reflectance colorimeter from HunterLab to measure their whiteness index according to CIE (The International Commission on Illumination) which is equivalent to the whiteness index published in ASTM Method E313 in 1998.

The anti-redeposition performance of the laundry detergent compositions with SRP polymers according to the present invention and of the laundry detergent composition without polymer is assessed based on the following formula:

ΔWI CIE=WI CIEwhite−WI CIEwash

The effectiveness of the soil anti-redeposition of the laundry detergent compositions with the readily biodegradable SRP polymers according to the present invention is reflected with lower ΔWI CIE values as shown in Table 5 below.

Table 5: The Effectiveness of the Soil Anti-Redeposition of the Laundry Detergent Compositions with SRP Polymers According to the Present Invention.

TABLE 5-1

| Com- | | Com- | Com- | | |
|---|---|---|---|---|---|
| position/ | | parative | parative | Com- | Com- |
| Test | | com- | com- | position | position |
| fabrics | Control | position 1 | position 2 | 1 | 2 |
| Test | 50.5 | 0.4 | 0.9 | 3.6 | 10.9 |
| fabric 1 | | | | | |
| Test | 12.8 | 2.3 | 2.3 | 2.8 | 3.8 |
| fabric 2 | | | | | |
| Test | 16.1 | 1.0 | 0.7 | 1.8 | 4.5 |
| fabric 3 | | | | | |
| Test | 3.3 | 0.6 | 0.6 | 0.7 | 1.3 |
| fabric 4 | | | | | |
| Test | 1.1 | 0.1 | 0.7 | 1.3 | −0.1 |
| fabric 5 | | | | | |
| Test | 1.1 | 1.1 | 0.9 | 0 | 0.8 |
| fabric 6 | | | | | |
| Total | 84.8 | 5.5 | 6.2 | 10.2 | 21.1 |

TABLE 5-2

| | | Compara- | Compara- | | | |
|---|---|---|---|---|---|---|
| | | tive | tive | | | |
| Test | | composi- | composit | Compo- | Compo- | Compo- |
| fabrics | Control | tion 1 | ion 2 | sition 3 | sition 4 | sition 5 |
| Test fabric | 47.4 | −0.5 | −0.5 | 14.5 | 33.9 | 0.6 |
| 1 | | | | | | |
| Test fabric | 11.5 | 2.3 | 2.7 | 8.5 | 11.1 | 2.6 |
| 2 | | | | | | |
| Test fabric | 10.3 | 0.7 | 0.8 | 5.7 | 8.1 | 1.1 |
| 3 | | | | | | |
| Test fabric | −1.4 | −3.1 | −2.7 | −2.6 | −2.3 | −3.4 |
| 4 | | | | | | |
| Test fabric | −3 | −2 | −2.3 | −3 | −3.6 | −3.6 |
| 5 | | | | | | |
| Test fabric | −12 | −8.5 | −9.1 | −7.9 | −9.8 | −10.7 |
| 6 | | | | | | |
| Total | 52.8 | −11.1 | −11.1 | 15.2 | 37.4 | −13.4 |

The test results in table 5-1 and table 5-2 were run at different batch, thus shown separately. As shown by the results in Table 5, the presence of S1 to S5 according to the present invention in the laundry detergent compositions works well in the soil anti-redeposition performance test across different type of test fabrics.

1. A biodegradable soil release polyester polymer represented by the general formula (I) 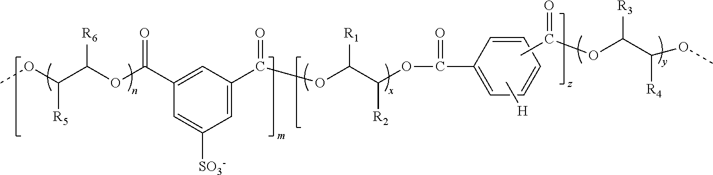
wherein
R₁, R₂, R₃, R₄, R₅ and R₆ are independently selected from H or C₁-C₈ alkyl;
x is a number ranging from 1 to 220;
y is a number ranging from 1 to 50;
z is a number ranging from 1 to 70;
m is a number ranging from 1 to 70; and
n is a number ranging from 1 to 220.

2. The biodegradable soil release polyester polymer according to claim 1, wherein the biodegradable soil release polyester polymer is prepared from a monomer composition comprising:
(a) a sulphonated dicarboxylic acid or the C₂ to C₆ fatty dihydric alcohol ester thereof (SA), wherein the sulphonated dicarboxylic acid (SA) is selected from the group consisting of at least one sulphonated aromatic or sulphonated aliphatic dicarboxylic acid or the derivatives thereof;
(b) a polyhydric polyol (P) selected from the polyethylene glycol or polypropylene glycol or the copolymer thereof having an alkylene oxide number ranging from 1 to 200;
(c) a diacidic component which is at least one selected from
c1) an unsulphonated dicarboxylic acid monomer (A) consisting of at least one dicarboxylic acid or derivatives thereof selected from the group consisting of terephthalic, isophthalic, 2,6-naphthalenedicarboxylic acids and furan dicarboxylic acid; and
c2) a polyester prepolymer prepared from the unsulphonated dicarboxylic acid monomers (A) or derivatives thereof and an alcohol selected from at least one of ethylene glycol, propylene glycol, diethylene glycol, triethylene glycol, tetraethylene glycol or polyethylene glycol having an ethylene oxide number ranging from 1 to 200, dipropylene glycol, glycerol, 1,2,4-butanetriol and 1,2,3-butanetriol, and oligomers of thereof having from 1 to 100 monomer units.

3. The biodegradable soil release polyester polymer according to claim 2, wherein the sulphonated dicarboxylic acid monomer (SA) is one or more selected from the group consisting of sulphoisophthalic, sulphoterephthalic, sulpho-ortho-phthalic acids or anhydrides, 4-sulpho-2,7-naphthalenedicarboxylic acids or anhydrides, sulpho-4,4′-bis(hydroxycarbonyl)diphenyl sulphones, sulphodiphenyldicarboxylic acids or anhydrides, sulpho-4,4′-bis(hydroxycarbonyl)diphenylmethanes, sulpho-5-phenoxyisophthalic acids or anhydrides, sulphosuccinic acids or anhydrides or lower diesters thereof.

4. The biodegradable soil release polyester polymer according to claim 2, wherein the C₂ to C₆ fatty dihydric alcohol is selected from ethylene glycol, propylene glycol or the combination thereof.

5. The biodegradable soil release polyester polymer according to claim 2, wherein the diacidic component is a polyester prepolymer prepared from the unsulphonated dicarboxylic acid monomers (A) or derivatives thereof and an alcohol selected from at least one of ethylene glycol, propylene glycol, diethylene glycol, triethylene glycol, tetraethylene glycol or polyethylene glycol having an ethylene oxide number ranging from 1 to 200, dipropylene glycol, glycerol, 1,2,4-butanetriol and 1,2,3-butanetriol, and oligomers of thereof having from 1 to 100 monomer units.

6. The biodegradable soil release polyester polymer according to claim 5, wherein the biodegradable soil release polyester polymer is prepared by transesterification reaction among the sulphonated dicarboxylic acid of C₂ to C₆ fatty dihydric alcohol ester (SA), polyhydric polyol (P) and the diacid component.

7. A cleaning composition, comprising:
(I) a surface-active agent selected from the group consisting of anionic surfactants, cationic surfactants, nonionic surfactants, amphoteric surfactants, and combinations thereof, in an amount ranging from 3 to 60 wt. % based on 100 wt. % of the cleaning composition; and
(II) a biodegradable soil release polyester polymer according to claim 1.

8. The cleaning composition according to claim 7, wherein the anionic surfactant is one or more selected from the group consisting of fatty acid soap, an ether carboxylic acid and salt thereof, an alkane sulphonate salt, an alpha-olefin sulphonate salt, a sulphonate salt of a higher fatty acid ester, a higher alcohol ester salt, fatty alcohol ether sulfate salts, an alkaryl sulfate, sulphonate or salt thereof, a higher alcohol phosphate ester salt, and a fatty alcohol ether phosphate ester salt, an alkyl glycerol sulphonate, sulfate or salt thereof, or a condensate of higher fatty acids.

9. The cleaning composition according to claim 7, wherein the cleaning composition is a fabric care composition, dish cleaning composition, home care composition, personal care composition or health care composition.

10. The cleaning composition according to claim 7, wherein the cleaning composition is a product selected from the group consisting of liquid laundry detergents, solid laundry detergents, laundry soap products, laundry spray treatment products, laundry pre-treatment products, hand dish washing detergents, automatic dishwashing detergents, a beauty care detergent, hard surface cleaning detergents, carpet cleaning detergents, a shampoo, and a household cleaning detergent.

11. The cleaning composition according to claim 7, wherein the composition is a laundry detergent composition.

12. The cleaning composition according to claim 11, wherein the composition is a solid laundry detergent or laundry soap product.

13. The cleaning composition according to claim 7, further comprising hydrotropic agents, enzymes, detergency builders, bleach, dyes, whitening agents, auxiliary additives and mixtures thereof.
